(19) United States
(12) Patent Application Publication
(10) Pub. No.: US 2016/0056918 A1
(43) Pub. Date: Feb. 25, 2016

(54) REDUNDANCY SYSTEM AND METHODS FOR USE WITH A TELECOMMUNICATION SYSTEM

(71) Applicant: Comtech EF Data Corp., Tempe, AZ (US)

(72) Inventor: Richard M. Miller, Gilbert, AZ (US)

(21) Appl. No.: 14/834,183

(22) Filed: Aug. 24, 2015

Related U.S. Application Data
(60) Provisional application No. 62/041,334, filed on Aug. 25, 2014.

(51) Int. Cl. H04L 1/00; H04L 12/939

(52) U.S. Cl. CPC H04L 1/0041; H04L 49/552; H04L 1/0045

(57) ABSTRACT

A redundancy system for co-channel telecommunications comprising a first modem comprising a premapped symbol interface (PMSI) ROM configured to produce a constellation point number (CPN) value for each transmitted symbol using FEC codewords and a modulation format, an encoder to produce three CPN value signals, and a first symbol clock to generate a timing signal for the data signal. The system further comprises a second modem comprising a PMSI ROM decoder to decode the CPN values from the received CPN value signals, an interface bus to transmit the three CPN value signals of the encoder and the timing signal from the first online modem to the second offline modem, and a redundancy switch to switch the input channel of data to a FEC encoder of the second modem and the output channel of received codewords to a FEC decoder of the first modem in response to a redundancy switching signal.

### CROSS REFERENCE TO RELATED APPLICATIONS

This document claims the benefit of the filing date of U.S. Provisional Patent Application No. 62/041,334, entitled “Redundancy System and Methods for Use With a Telecommunication System” to Richard M. Miller, which was filed on Aug. 25, 2014, the disclosure of which is hereby incorporated entirely by reference herein.

### BACKGROUND

1. Technical Field

Aspects of this document relate generally to telecommunication systems and techniques for transmitting data across a telecommunication channel.

2. Background Art

In many satellite communications and other wireless applications, it is considered highly advantageous to protect links from outages caused by equipment failures through the use of redundant equipment that is automatically substituted to carry communications traffic, should an equipment failure be detected. Systems providing this functionality are commonly referred to as protection switches or redundancy switches.

It is desirable in a redundancy system to continuously monitor not only the health of the units actively carrying traffic (also referred to as online units), but also the health of the backup system (also referred to as the offline unit). This gives an increased confidence that in the event of the failure of an online unit, the backup system will function as expected.

In a satellite communications system employing modems using Carrier-in-Carrier™ technology (a system that permits a full-duplex transmit/receive link to occupy identical frequencies) in a redundant configuration, the received signal to be demodulated is split to feed the demodulators in both online and offline units. It is important to note that the received signal comprises the desired signal plus co-channel interference. This co-channel interference is a delayed copy of the transmit signal from the local end, at the same frequency as the signal being received from the distant end, and, in order to remove (cancel) this co-channel interference, the cancellation signal processing block needs a perfect copy of the original transmit signal. For the online modem, it is a straightforward matter to route the copy of the transmit signal to the cancellation signal processing block. But, if the offline unit is to successfully cancel that same transmit signal, it too needs to obtain a copy of the transmit signal. The offline unit is almost always in a physically different enclosure, which may be located at a considerable distance from the online unit.

The U.S. Patents and/or Publications subsequently referred to in this disclosure are hereby incorporated by this reference in their entirety.

U.S. Pat. Nos. 8,022,781 and 8,400,228 to Miller provide a system that implements redundancy in systems using adaptive co-channel cancellation techniques for frequency re-use as described in U.S. Pat. Nos. 6,859,641 and 7,228,104 to Collins, et al. As disclosed, the system addresses the need to provide a faithful copy of the reference transmit signal (the deliberate interferer, which is then time aligned and subtracted from the composite of the desired signal and the interferer) to a second adaptive canceller, when redundancy is required to improve overall system availability. These patents are relevant to, but are not limited to the field of satellite communications, using digital modulation schemes that include, but are not limited to, simple BPSK and QPSK, and higher-order modulation schemes such as 16-QAM, which has broad application in the field of wireless communications.

### SUMMARY

According to an aspect of the disclosure, a redundancy system for co-channel telecommunications may comprise a first modem with a FEC encoder configured to receive data to be transmitted via an input channel and generate FEC codewords, a symbol mapper configured to convert the FEC codewords into complex I/Q format, a premapped symbol interface (PMSI) ROM encoder configured to produce a constellation point number (CPN) value for each symbol to be transmitted using the FEC codewords and the modulation format, an encoder configured to encode the CPN values to produce three CPN value signals for transmission, a first symbol clock configured to generate a timing signal for the transmitted data signal, a RF down-conversion to complex digital baseband block configured to covert a received data signal to digital baseband, and an adaptive co-channel digital baseband canceller, a digital demodulator, and a FEC decoder configured to output the received decoded codewords via an output channel; and a second modem with a decoder configured to decode the three CPN value signals received from the encoder of the first modem, a second symbol clock configured to receive the timing signal generated by the first transmit symbol clock, a PMSI ROM decoder configured to decode the CPN values from the three received CPN value signals and generate complex I/Q values, an adaptive co-channel digital baseband canceller, a demodulator configured to demodulate the received data signal from the output of the adaptive co-channel digital baseband canceller, a FEC decoder configured to decode the received symbols to produce FEC codewords and output the received codewords via an output channel, an interface bus configured to transmit the three CPN value signals of the encoder and the timing signal from the first modem to the second modem when the first modem is online and the second modem is offline, and a redundancy switch configured to switch the input channel of data to be transmitted to a FEC encoder of the second modem and the output channel of the received codewords to a FEC decoder of the first modem in response to a redundancy switching signal such that the second modem becomes online and the first modem becomes offline.

Particular embodiments may comprise one or more of the following. At least one of the first and second modems may further comprise a symbol mapper configured to generate I and Q signals. At least one of the first and second modems may further comprise a polyphase FIR filter configured to receive at least one of the I and Q signals generated by the symbol mapper. The second modem may further comprise a multiplexer configured to route the I and Q signals and one or more of the timing signals to the polyphase FIR filter. The symbol mapper may be configured to map a constellation that is irregular or nonsymmetric in the I/Q plane. The modulation format may be at least one of BPSK, QPSK, 8-ARY, 16-ARY, 32-ARY or 64-ARY. The encoder may be a dual data rate (DDR) encoder and the decoder is a dual data rate (DDR) decoder. Each CPN value may correspond to one of 64 possible constellation points in the I/Q plane. The interface bus may be a PMSI bus. The interface bus may be an EIA-485 interface bus.

According to an aspect of the disclosure, a method for redundancy within a co-channel telecommunications system may comprise generating FEC codewords using a FEC encoder of a first modem that receives data to be transmitted via an input channel, modulating the FEC codewords using a modulation format by a modulator of the first modem to produce a data signal, producing, using a premapped symbol interface (PMSI) ROM of the first modem, a constellation point number (CPN) value for each symbol to be transmitted using the FEC codewords and the modulation format, encoding the CPN values to produce three CPN value signals for transmission using an encoder of the first modem, generating a timing signal for the transmitted data signal using a first symbol clock of the first modem, transmitting the three CPN value signals of the encoder and the timing signal from the first modem to a second modem when the first modem is online and the second modem is offline using an interface bus, decoding the three CPN value signals received from the encoder of the first modem using a decoder of the second modem, receiving the timing signal generated by the first symbol clock for use as a transmit symbol clock of the second modem, decoding the CPN values from the three received CPN value signals using a PMSI ROM decoder of the second modem, receiving the decoded CPN values, in I/Q format, by at least one polyphase transmit filter, receiving, by an adaptive co-channel digital baseband canceller, an output of the at least one polyphase transmit filter as a reference input, receiving an output from the adaptive co-channel digital baseband canceller and demodulating the received data signal using a demodulator of the second modem, decoding the received data signal to produce FEC codewords and output the received codewords via an output channel using a FEC decoder of the second modem, and switching the input channel of data to be transmitted to a FEC encoder of the second modem and the output channel of the received codewords to a FEC decoder of the first modem using a redundancy switch in response to a redundancy switching signal such that the second modem becomes online and the first modem becomes offline.

Particular embodiments may comprise one or more of the following. Generating I and Q signal using a symbol mapper of at least one of the first and second modems. Receiving at least one of the I and Q signals generated by the symbol mapper using a polyphase FIR filter of at least one of the first and second modems. Routing the I and Q signals and one or more of the timing signals to the polyphase FIR filter using a multiplexer of the second modem. Mapping a constellation that is irregular or nonsymmetric in the I/Q plane using the symbol mapper. The modulation format may be at least one of BPSK, QPSK, 8-ARY, 16-ARY, 32-ARY or 64-ARY. The encoder may be a dual data rate (DDR) encoder and the decoder is a dual data rate (DDR) decoder. Each CPN value may correspond to one of 64 possible constellation points in the I/Q plane. The interface bus may be a PMSI bus. The interface bus may be an EIA-485 interface bus.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographer, to use only the plain and ordinary meaning of terms in the specification and claims unless he clearly states otherwise and then further, expressly set forth the “special” definition of that term and explain how it differs from the plain and ordinary meaning Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of post-AIA 35 U.S.C. §112(f). Thus, the use of the words “function,” “means” or “step” in the Description , Drawings, or Claims is not intended to somehow indicate a desire to invoke the special provisions of post-AIA 35 U.S.C. §112(f), to define the invention. To the contrary, if the provisions of post-AIA 35 U.S.C. §112(f) are sought to be invoked to define the claimed disclosure, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of post-AIA 35 U.S.C. §112(f). Moreover, even if the provisions of post-AIA 35 U.S.C. §112(f) are invoked to define the claimed disclosure, it is intended that the disclosure not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 provides an exemplary satellite communications system in which local and remote satellite terminals use the same allocated bandwidth and center frequency for transmission of their respective carrier signals as known in the prior art.

FIG. 2 is an example of an implementation of a system for redundant co-channel telecommunications.

FIGS. 3A-F provide exemplary constellation diagrams for a various modulation formats.

### DESCRIPTION

This disclosure, its aspects and implementations, are not limited to the specific components, frequency examples, redundancy configurations or methods disclosed herein. Many additional components and assembly procedures known in the art consistent with embedding meta-data techniques are in use with particular implementations from this disclosure. Accordingly, for example, although particular implementations are disclosed, such implementations and implementing components may comprise any components, models, versions, quantities, and/or the like as is known in the art for such systems and implementing components, consistent with the intended operation.

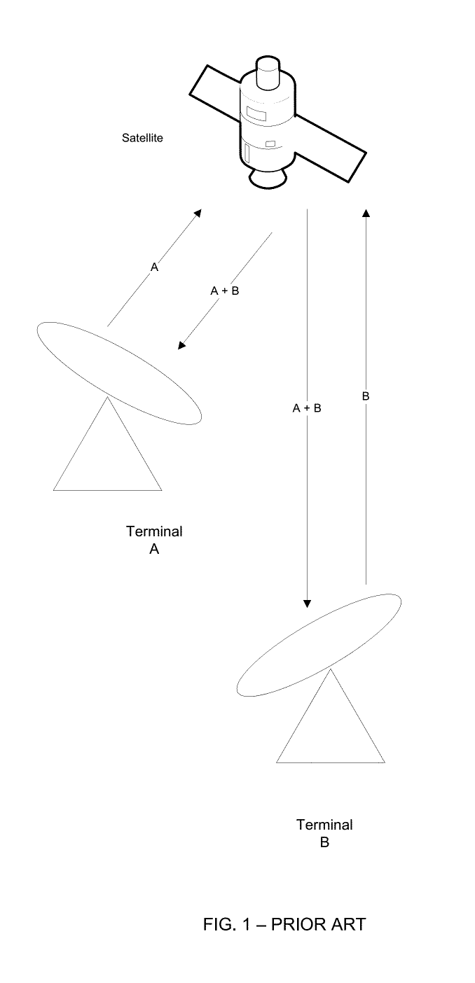

An exemplary satellite communications system is provided in FIG. 1. As shown, the signal of interest at Terminal A may be signal B, the signal being transmitted by Terminal B. Because the telecommunications link is a full duplex co-channel link, signal A and signal B, once received by the satellite, are additively combined and retransmitted to both Terminals A and B on the same channel as the combined signal A+B. Because of this, both Terminals A and B be required to cancel their own outbound transmitted signal from the received combined signal A+B in order to retrieve their respective signals of interest (signal A or signal B). Because each terminal's transmitted signal (either signal A or signal B) is subsequently received as the interfering signal in the combined signal A+B, the interfering signal is time-delayed and may be frequency shifted relative to the original transmitted signal. One of the functions of the Co-Channel Digital Baseband Cancellers in the moderns associated with Terminal A or B is to compensate for that time-delay and frequency offset in order to successfully cancel the interfering signal.

U.S. Pat. Nos. 8,022,781 and 8,400,228, incorporated by reference above, describe a method whereby the copy of a reference transmit signal, represented in complex baseband (I, Q) format, is communicated to the second (redundant) adaptive canceller using a Pre-Mapped Symbol Interface (PMSI), comprising a PMSI encoder, a dual-data rate (DDR) interface (to reduce the number of parallel electrical lines needed, and in the specific case cited, using an EIA-485 physical electrical interface), and a PMSI decoder, which together permit an exact replica of the original complex baseband signal to be transmitted, over considerable distance, and at data rates up to 30 Msymbols/second, using the aforementioned EIA-485 interface. Implementations of the physical electrical interface use, but are not limited to, EIA-485. For operation at symbol rates beyond 30 Msymbols/second, other physical electrical interfaces may be used, such as Low Voltage Differential Signaling (LVDS), which can potentially operate at rates up to several hundred Msymbols/second. The above-referenced patents describe a scheme that minimizes the number of electrical conductors needed for transmitting a copy of the transmit reference signal.

This disclosure has specific application when co-channel interference cancellation techniques are used in order to allow forward and return satellite links to simultaneously share the exact same bandwidth. This results in a significant savings in satellite transponder bandwidth, potentially doubling the capacity.

In some system configurations, a local and a remote satellite terminal use the exact same allocated bandwidth and center frequency for transmission of their respective carrier signals as depicted in FIG. 1. At the local station, the signal presented to the demodulator comprises not only the desired signal from the remote side, but also the local terminal's own outbound signal, which is subject to the round trip delay of the signal from the ground to the geostationary satellite, and back again.

This basic technique relies on having perfect a priori knowledge of the interfering signal. The signal processing performed must determine, very accurately, the time delay between the local transmit signal and the delayed copy of that same signal being received as the co-channel interferer. The signal processing must then delay a copy of the original transmit signal by the exact same amount, and having the correct frequency, phase and amplitude to cancel out the interferer. If this is accomplished, the result of the cancellation technique yields just the desired signal, which can then be demodulated using a conventional approach. The net result is that two carrier signals can lie directly on the top of each other, sharing the same bandwidth, hence doubling spectral efficiency.

The cancellation can be performed at RF or IF frequencies, but in some instances, it may be preferred to use baseband signals—those that have been translated to zero, or near zero, frequency. One benefit of this approach is that the Nyquist-filtered baseband signals (in I and Q format) can be fed to the canceller in either analog or digital form, prior to being modulated onto an RF carrier.

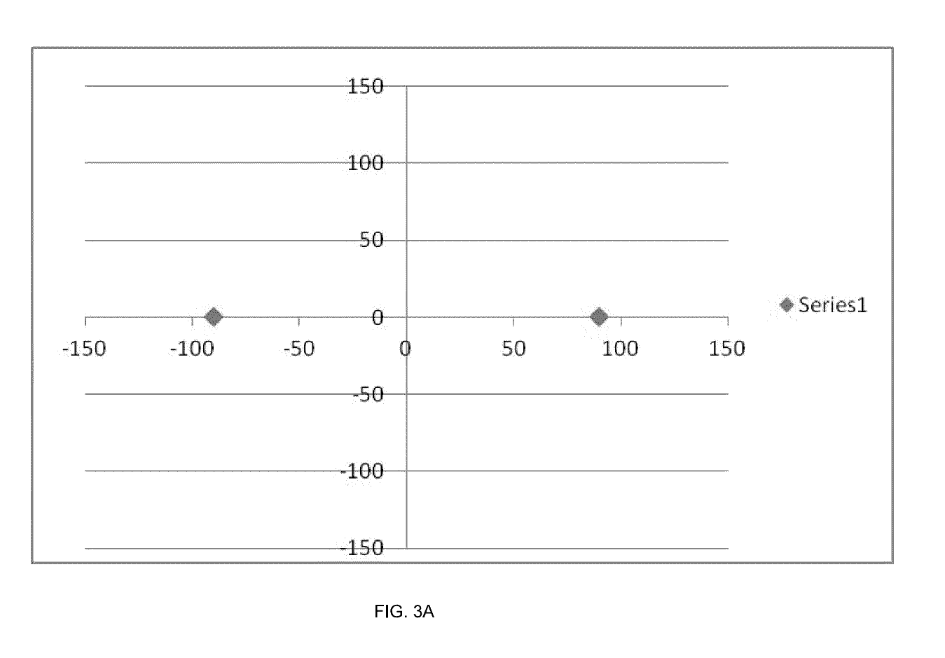

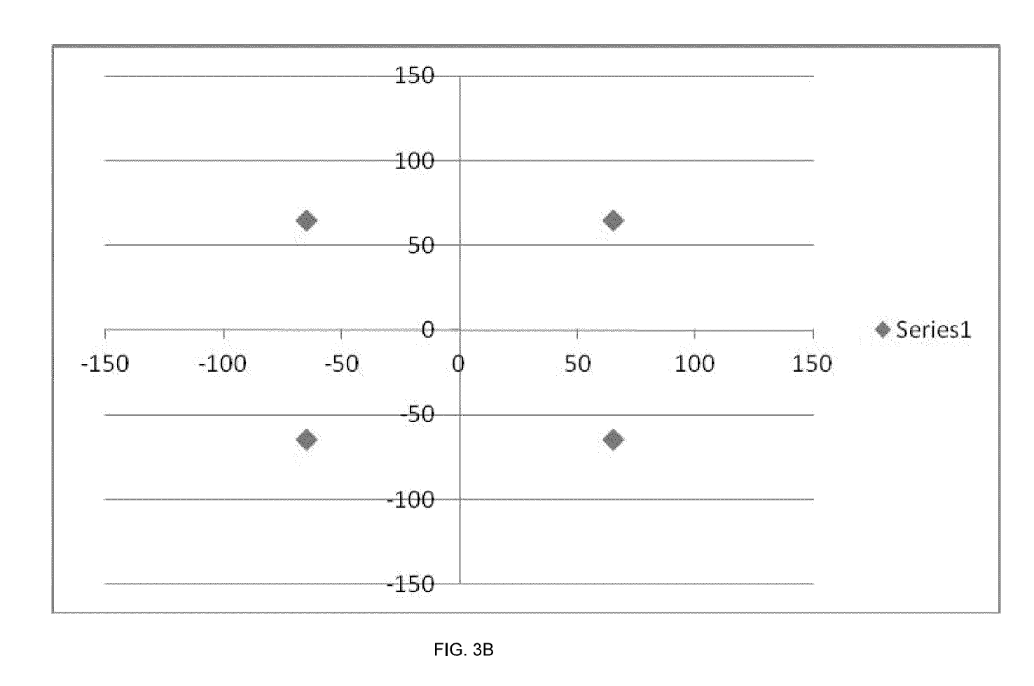

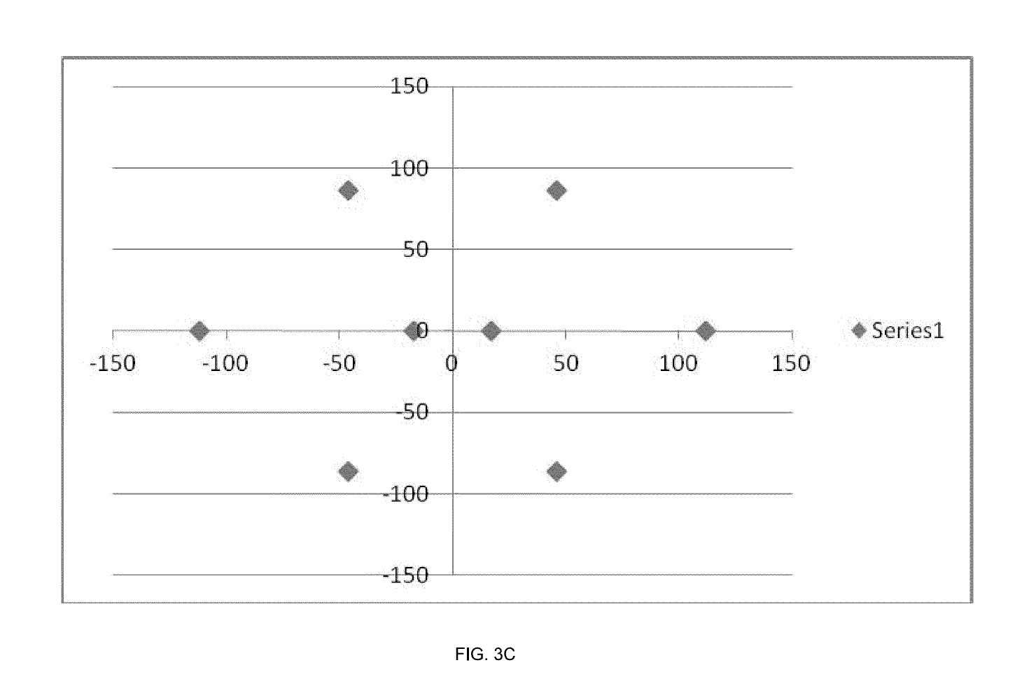

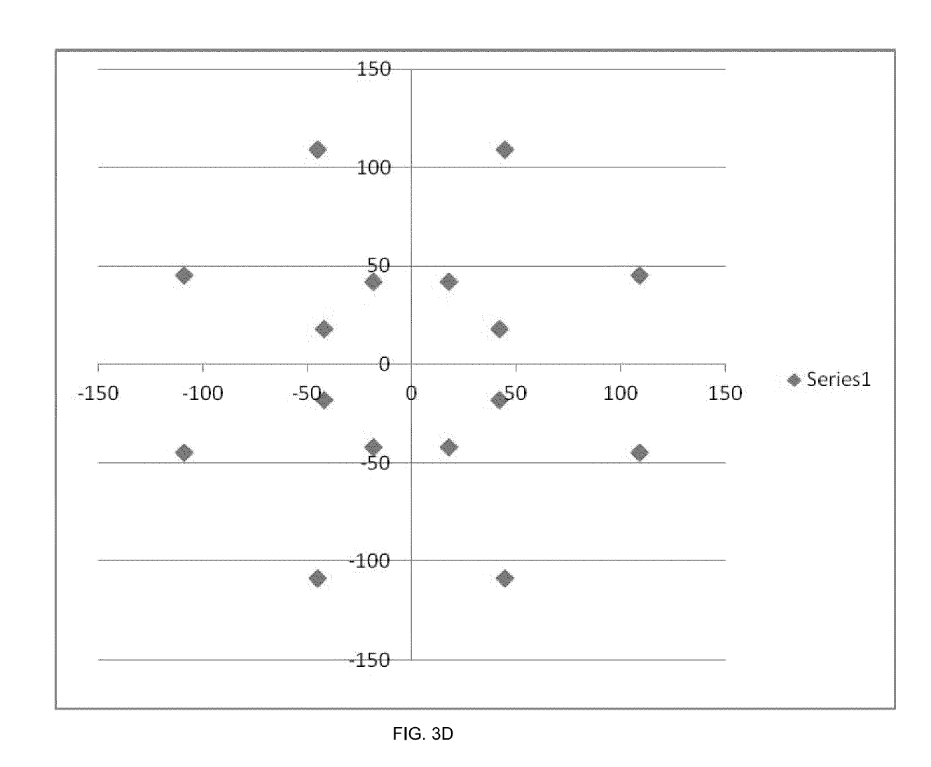

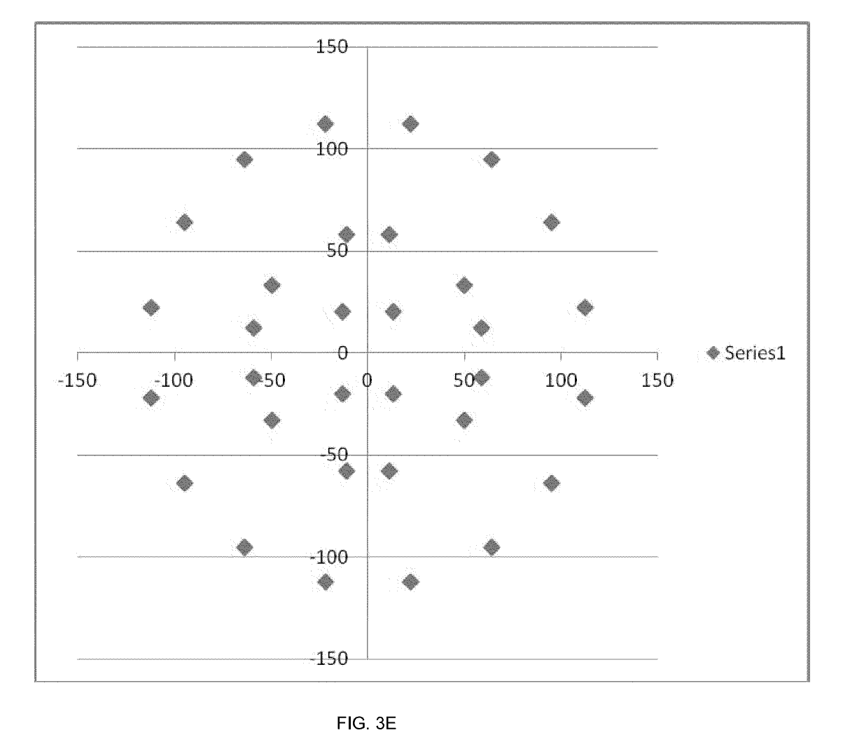

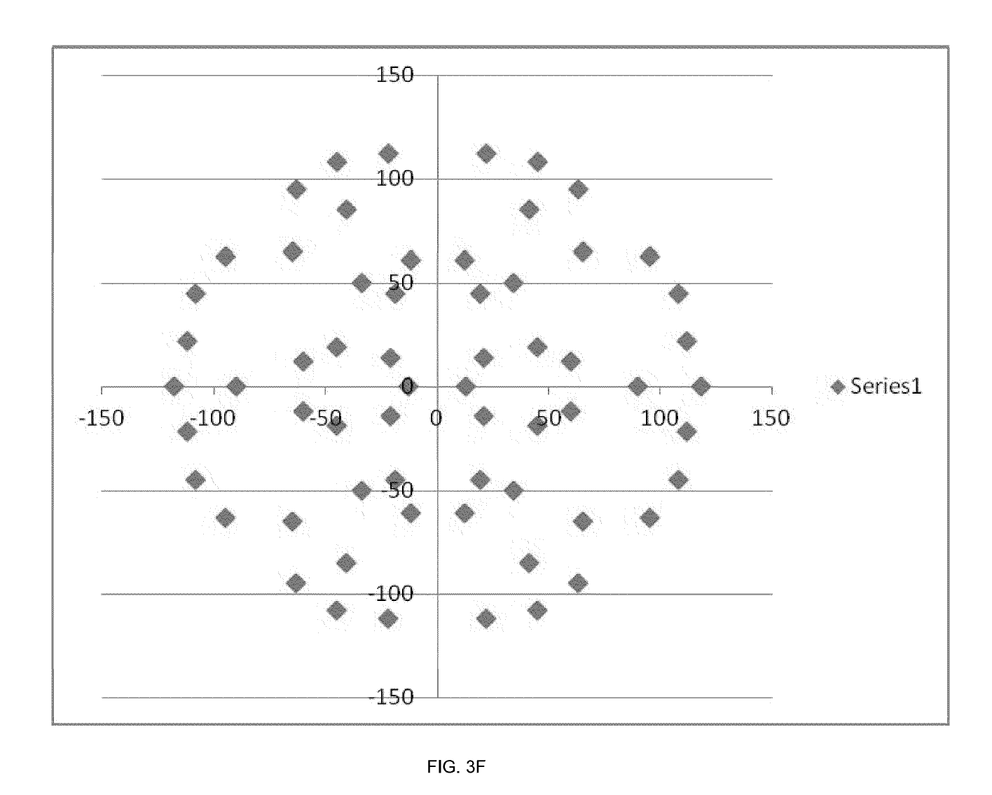

This disclosure describes implementations of methods and systems whereby the capacity of the scheme disclosed in U.S. Pat. Nos. 8,022,781 and 8,400,228 is doubled or quadrupled, while maintaining the same number of electrical conductors. Furthermore, the scheme as disclosed herein is no longer limited to ‘regular’ and ‘symmetric’ signal constellations In the context of this disclosure a regular, symmetric signal constellation is one in which the Euclidean distance between constellation points is maximized, and there is perfect symmetry of constellation points about both I and Q axes in the complex plane. Examples of regular, symmetric signal constellations are illustrated in FIGS. 3A and 3B. An example of a non-regular, symmetric signal constellation is shown in FIG. 3D. An example of a non-regular, non-symmetric signal constellation is shown in FIG. 3E. Non-regular, non-symmetric (arbitrary) symbol mappings are permitted when using implementations of the systems and methods described herein.

The ability to use arbitrary symbol mapping is highly advantageous because modern wireless communications systems have advanced to include combinations of symbol mapping, modulation order and Forward Error Correction (FEC) that yield constellations that are neither regular, nor symmetrical, and because the use of Adaptive Coding and Modulation (ACM) in the environment in which adaptive co-channel cancellation techniques for frequency re-use are in operation, flexibility is required in describing symbol mapping, and ‘on-the-fly’ changes.

In earlier times, the transmit digital baseband filtering architecture used in satellite modems was based on the linear superposition of ‘n’ parallel one-dimensional stored waveform transversal digital filters. This provided an efficient hardware implementation, given available technology. In this older approach, rather than performing FIR filtering on the output from an I/Q symbol mapper which is N bits wide (where N may be 16 or higher), the symbol mapping process decomposes the amplitudes of constellation points into two values, an MSB and an LSB, for both I and Q axes. This older method requires regular, symmetric constellation types, such as QPSK and 16-QAM. In systems employing both redundancy and Adaptive Coding and Modulation (ACM), the modulation format needs to be communicated to the off-line unit, in addition to the amplitude information. However, for non-regular, non-symmetric constellations, the decomposition into MSB and LSB values is not suitable, and, particularly for higher-order modulations, a symbol mapper is required that takes codewords from the FEC encoder and maps them into, as a non-limiting example, 8 bit values, for both I and Q, in a complex baseband representation.

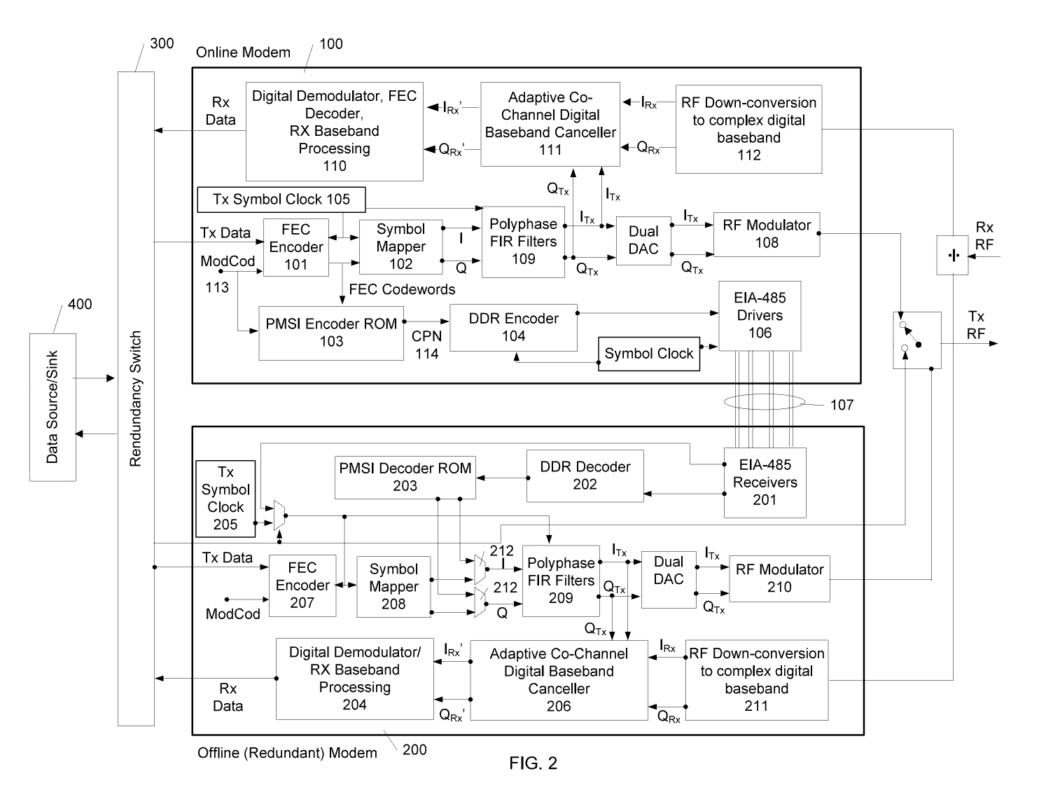

FIG. 2 provides a block diagram of an exemplary implementation of a redundancy system in accordance with this disclosure. The first, online modem 100 and second, offline modem 200 are coupled to a redundancy switch 300 that is configured to provide 1:1 redundancy by generating a switching signal such that the online modem becomes offline and the offline modem becomes online in response to a failure in performance of the online modem 100. While FIG. 2 depicts the interface bus and overall system configuration in a one-directional manner, this is merely for the purpose of simplicity and it should be understood that the system and interface bus are intended to be bi-directional such as for example, when the online modem 100 becomes offline and the offline modem 200 becomes online. The redundancy switch 300 is coupled to the data source/sink 400 and as shown, data source/sink 400 provides data to be transmitted to the FEC encoder 101 of the online modem 100, (and FEC encoder 207 of the offline modem) which produces FEC codewords that are fed to the symbol mappers 102 and 208 which generate I and Q signals in complex baseband format. The FEC codewords in the online modem 100 are also fed to a pre-mapped symbol interface (PMSI) ROM 103 which utilizes the FEC codewords and a description of the modulation format defined by the ModCod 113 that is used by the modulator 108 (or 210 in the offline modem) and produces, for each symbol to be transmitted, a constellation point number (CPN) value 114. These CPN values 114 are then encoded using, for example, a dual data rate (DDR) encoder 104 to produce three CPN value signals. A transmit symbol clock 105 of the first, online modem 100 is used to generate a timing signal for the transmitted data. The first, online modem 100 comprises one or more polyphase FIR filters 109 that receive the I and Q symbols from the symbol mapper 102 in baseband format. from which I_{TX} and Q_{TX} are routed to the Adaptive Co-Channel Digital Baseband Canceller 111. The first, online modem 100 further comprises a RF down-conversion to complex digital baseband block 112 that coverts a received data signal to digital baseband and provides this received data signal in complex baseband form to an adaptive co-channel digital baseband canceller 111 which also receives I_{TX} and Q_{TX} from the one or more polyphase filters 109. A digital demodulator and a FEC decoder 110 then receive the adaptive co-channel digital baseband canceller 111 output and proceed to output the received decoded codewords via an output channel.

While implementations of the disclosed system and methods are applicable when using other communications standards, FIG. 2 provides an exemplary implementation that utilizes the EIA-485 standard. The EIA-485 drivers 106 translate the three CPN value signals and the timing signal from the symbol clock into four differential pairs, which are then transmitted via an interface bus 107 to the EIA-485 receivers 201 of the second, offline modem 200. The interface bus 107 may comprise any appropriate interface bus such as, by non-limiting example, and EIA-485 or LVDS interface bus.

In the offline modem 200, the reciprocal process takes place. EIA-485 line receivers 201 provide inputs to a DDR decoder 202, converting the differential signals received across the interface bus 107 into four single-ended signals, comprising the three CPN values as well as the transmit symbol clock timing signal. These CPN values are then used by a PMSI decoder ROM 203, which regenerates the online symbol mapper values (8-bits as a non-limiting, example) for I and Q inputs to one or more polyphase FIR filters 209. A simple multiplexer 212 arrangement may be used to accomplish the routing of the symbol mapper values and the transmit symbol clock 205 timing signal. The signals at the output of the polyphase FIR filters 209 (used for Nyquist filtering of the baseband signals) I_{TX} and Q_{TX} are routed to the Adaptive Co-Channel Digital Baseband Canceller 206. The complex signals from the RF down-conversion to complex digital baseband block 211, I_{RX} and Q_{RX}, comprising the desired signal plus the co-channel interferer, comprise the primary input to the Adaptive Co-Channel Digital Baseband Canceller 206, and after cancellation has been performed, the desired signal, represented by I_{RX}′ and Q_{RX}′ are fed to the Digital demodulator/Rx baseband processing 204. In this manner the signals I_{TX} and Q_{TX} in modem 100 are accurately reproduced as I_{TX} and Q_{TX} in modem 200, using a simple, inexpensive cable, and potentially at a considerable physical distance away.

The use of Adaptive Coding and Modulation (ACM) is becoming increasingly important in satellite communications in order to maximize data throughput under varying link conditions as illustrated by such commercial examples as DVB-S2 and Comtech EF Data's VersaFEC™. In ACM, there is a choice of modulation formats and FEC Code Rates (known as ModCods) that make up the ACM set, and as link conditions vary, the ACM controller determines which ModCod will optimize throughput.

The pre-mapped symbol interface (PMSI), as disclosed in the prior art and discussed above with reference to FIG. 2, relies on a methodology whereby the offline unit is provided with a copy of the transmit reference using an interface bus such as a simple EIA-485 interface bus, that comprises four differential pairs, plus a ground conductor, for a total of 9 conductors. The PMSI supports this ACM mode of operation, but in the prior art, the number of different modulation types in the ACM set is limited.

FIGS. 3A-F provide examples of possible constellations using BPSK, QPSK, 8-ARY, 16-ARY, and 32-ARY modulation formats as well as a superposition of all of these exemplary constellations, respectively. As shown in FIG. 3F, the superposition of all five modulation format types comprises 62 unique points in the I/Q plane. In some implementations, each of these 62 points may be assigned a unique Constellation Point Number (CPN) with values 0 to 61, as a non-limiting example.

Furthermore, these 62 points may be represented by six bits (two raised to the 6th power=64 so in this example, six bits is adequate, and can describe up to 64 unique Constellation Point Numbers). If these six bits are transferred using a dual-data rate (DDR) scheme in which data is transferred on both edges of a symbol clock, all 62 (up to a maximum of 64) unique values may be transmitted on just three interchange circuits.

The system and methods of this disclosure may provide numerous advantages over those of the prior art. For example, in the prior art, when operating in an ACM mode with a set of four different modulation types, the modulation formats were limited to 16-QAM, when using four differential pairs in the PMSI interface cable: two pairs for the I, Q, most significant bits (MSBs), and least significant bits (LSBs); one pair to carry the two bits describing the modulation order; and one pair to carry the symbol clock timing. When utilizing implementations of methods as described in this disclosure, the capacity is increased to include 32-ARY, using the same 4 differential pairs. Thus, the disclosed systems and methods allow for the capacity of the interface to be doubled or quadrupled by replacing the I, Q, MSBs, and LSBs with Constellation Point Numbers (CPNs).

As discussed above, implementations of the disclosed methods also remove the need for constellations to be regular or symmetric. The use of CPNs permits totally arbitrary constellation mappings. However, if the constellations are regular and symmetric, modulation up to 64-ary can be supported with just 4 differential pairs. The scheme could support, as a non-limiting example, an ACM set comprising BPSK, QPSK, 8-QAM, 32-QAM and 64-QAM.

The methods and systems described in this disclosure may utilize one or more of the following hardware components: Field-Programmable Gate Array (FPGA), Programmable Logic Device (PLD), Programmable Integrated Circuit (PIC), Digital Signal Processor (DSP), or Application Specific Integrated Circuit (ASIC) using conventional implementation methods known in the art with knowledge of this disclosure.

In places where the description above refers to particular implementations of telecommunication systems and techniques for transmitting data across a telecommunication channel, it should be readily apparent that a number of modifications may be made without departing from the spirit thereof and that these implementations may be applied to other to telecommunication systems and techniques for transmitting data across a telecommunication channel.

1. A redundancy system for co-channel telecommunications comprising:
a first modem comprising:
a FEC encoder configured to receive data to be transmitted via an input channel and generate FEC codewords;
a symbol mapper configured to convert the FEC codewords into complex I/Q format;
a premapped symbol interface (PMSI) ROM encoder configured to produce a constellation point number (CPN) value for each symbol to be transmitted using the FEC codewords and the modulation format;
an encoder configured to encode the CPN values to produce three CPN value signals for transmission;
a first symbol clock configured to generate a timing signal for the transmitted data signal;
a RF down-conversion to complex digital baseband block configured to covert a received data signal to digital baseband; and
an adaptive co-channel digital baseband canceller, a digital demodulator, and a FEC decoder configured to output the received decoded codewords via an output channel;
a second modem comprising:
a decoder configured to decode the three CPN value signals received from the encoder of the first modem;
a second symbol clock configured to receive the timing signal generated by the first transmit symbol clock;
a PMSI ROM decoder configured to decode the CPN values from the three received CPN value signals and generate complex I/Q values;
an adaptive co-channel digital baseband canceller;
a demodulator configured to demodulate the received data signal from the output of the adaptive co-channel digital baseband canceller;
a FEC decoder configured to decode the received symbols to produce FEC codewords and output the received codewords via an output channel;
an interface bus configured to transmit the three CPN value signals of the encoder and the timing signal from the first modem to the second modem when the first modem is online and the second modem is offline; and
a redundancy switch configured to switch the input channel of data to be transmitted to a FEC encoder of the second modem and the output channel of the received codewords to a FEC decoder of the first modem in response to a redundancy switching signal such that the second modem becomes online and the first modem becomes offline.

2. The system of claim 1, wherein at least one of the first and second modems further comprises a symbol mapper configured to generate I and Q signals.

3. The system of claim 2, wherein at least one of the first and second modems further comprises a polyphase FIR filter configured to receive at least one of the I and Q signals generated by the symbol mapper.

4. The system of claim 3, wherein the second modem further comprises a multiplexer configured to route the I and Q signals and one or more of the timing signals to the polyphase FIR filter.

5. The system of claim 2, wherein the symbol mapper is configured to map a constellation that is irregular or nonsymmetric in the I/Q plane.

6. The system of claim 1, wherein the modulation format is at least one of BPSK, QPSK, 8-ARY, 16-ARY, 32-ARY or 64-ARY.

7. The system of claim 1, wherein the encoder is a dual data rate (DDR) encoder and the decoder is a dual data rate (DDR) decoder.

8. The system of claim 1, wherein each CPN value corresponds to one of 64 possible constellation points in the I/Q plane.

9. The system of claim 1, wherein the interface bus is a PMSI bus.

10. The system of claim 1, wherein the interface bus is an EIA-485 interface bus.

11. A method for redundancy within a co-channel telecommunications system comprising:
generating FEC codewords using a FEC encoder of a first modem that receives data to be transmitted via an input channel;
modulating the FEC codewords using a modulation format by a modulator of the first modem to produce a data signal;
producing, using a premapped symbol interface (PMSI) ROM of the first modem, a constellation point number (CPN) value for each symbol to be transmitted using the FEC codewords and the modulation format;
encoding the CPN values to produce three CPN value signals for transmission using an encoder of the first modem; and
generating a timing signal for the transmitted data signal using a first symbol clock of the first modem;
transmitting the three CPN value signals of the encoder and the timing signal from the first modem to a second modem when the first modem is online and the second modem is offline using an interface bus;
decoding the three CPN value signals received from the encoder of the first modem using a decoder of the second modem;
receiving the timing signal generated by the first symbol clock for use as a transmit symbol clock of the second modem;
decoding the CPN values from the three received CPN value signals using a PMSI ROM decoder of the second modem;
receiving the decoded CPN values, in I/Q format, by at least one polyphase transmit filter;
receiving, by an adaptive co-channel digital baseb and canceller, an output of the at least one polyphase transmit filter as a reference input;
receiving an output from the adaptive co-channel digital baseband canceller and demodulating the received data signal using a demodulator of the second modem;
decoding the received data signal to produce FEC codewords and output the received codewords via an output channel using a FEC decoder of the second modem; and
switching the input channel of data to be transmitted to a FEC encoder of the second modem and the output channel of the received codewords to a FEC decoder of the first modem using a redundancy switch in response to a redundancy switching signal such that the second modem becomes online and the first modem becomes offline.

12. The method of claim 11, further comprising generating I and Q signal using a symbol mapper of at least one of the first and second modems.

13. The method of claim 12, further comprising receiving at least one of the I and Q signals generated by the symbol mapper using a polyphase FIR filter of at least one of the first and second modems.

14. The method of claim 13, further comprising routing the I and Q signals and one or more of the timing signals to the polyphase FIR filter using a multiplexer of the second modem.

15. The method of claim 12, further comprising mapping a constellation that is irregular or nonsymmetric in the I/Q plane using the symbol mapper.

16. The method of claim 11, wherein the modulation format is at least one of BPSK, QPSK, 8-ARY, 16-ARY, 32-ARY or 64-ARY.

17. The method of claim 11, wherein the encoder is a dual data rate (DDR) encoder and the decoder is a dual data rate (DDR) decoder.

18. The method of claim 11, wherein each CPN value corresponds to one of 64 possible constellation points in the I/Q plane.

19. The method of claim 11, wherein the interface bus is a PMSI bus.

20. The method of claim 11, wherein the interface bus is an EIA-485 interface bus.
